(19) United States
(12) Patent Application Publication
(10) Pub. No.: US 2021/0125139 A1
(43) Pub. Date: Apr. 29, 2021

(54) METHOD AND SYSTEM OF WEIGHT-BASED PORTION INVENTORY CONTROL IN MIXOLOGY OF BEVERAGES

(71) Applicant: GREGORY INNOVATIONS, LLC, Carlsbad, NM (US)

(72) Inventor: Norman Scott Gregory, Carlsbad, NM (US)

(73) Assignee: GREGORY INNOVATIONS, LLC, Carlsbad, NM (US)

(21) Appl. No.: 16/666,883

(22) Filed: Oct. 29, 2019

(51) Int. Cl. G06Q 10/08; G01G 17/04; G06F 9/54

(52) U.S. Cl. CPC G06Q 10/087; C12G 3/04; G06F 9/542; G01G 17/04

(57) ABSTRACT

An example method includes receiving, from a first scale, a container weight of a first container. The method also includes receiving, from a second scale, a container weight of a second container. The method also includes receiving, from the first scale, a second container weight of the first container after a portion of liquid is removed from the first container, and receiving, from the second scale, a second container weight of the second container after the portion of the liquid is added to the second container. The method also includes determining a removed weight of the portion of the liquid from the first container, determining an added weight of the portion of the liquid in the second container, and determining whether the removed weight and added weight match a target weight.

### BACKGROUND

One example commercial environment may include a restaurant and/or bar where a beverage is acquired by a patron in exchange for a sum of money. Some restaurants and/or bars serve mixed drinks that include a combination of various types of liquids (e.g., alcoholic and/or non-alcoholic). The owners of the restaurants and/or bars spend a substantial amount of money to purchase the various types of liquids. Oftentimes, bartenders who make the mixed drinks “eyeball” the amount of liquid poured into a mixing container or cup. Such a technique may lead to over-pouring an amount of the liquid, which may lead to lost profits. In other instances, some bartenders may dispense the liquid free of charge to friends or regular customers, which may also lead to lost profits. Enhanced inventory control in mixology of beverages is desired.

### BRIEF DESCRIPTION OF THE DRAWINGS

For a detailed description of example embodiments, reference will now be made to the accompanying drawings in which:

FIG. 1 shows an overhead view of a bar using an example system in accordance with various embodiments;

FIG. 2 shows an example component diagram of the system in accordance with various embodiments;

FIG. 3 show an example transfer of liquid from a storage location to a mixing station using the system in accordance with various embodiments;

FIG. 4 shows an example of detecting that too much of a liquid was poured in accordance with various embodiments;

FIG. 5 shows an example of detecting that the wrong container of liquid was picked up by a bartender in accordance with various embodiments;

FIG. 6 shows an example of detecting that the wrong container of liquid is placed at a storage location in accordance with various embodiments;

FIG. 7 shows an example of detecting that the wrong container of liquid is scanned at the mixing station in accordance with various embodiments;

FIG. 8 shows an example user interface presenting a weight-based inventory of liquids in accordance with various embodiments;

FIG. 9 shows a method in accordance with various embodiments;

FIG. 10 shows a method in accordance with various embodiments;

FIG. 11 shows a method in accordance with various embodiments;

FIG. 12 shows a method in accordance with various embodiments;

FIG. 13 shows a method in accordance with various embodiments; and

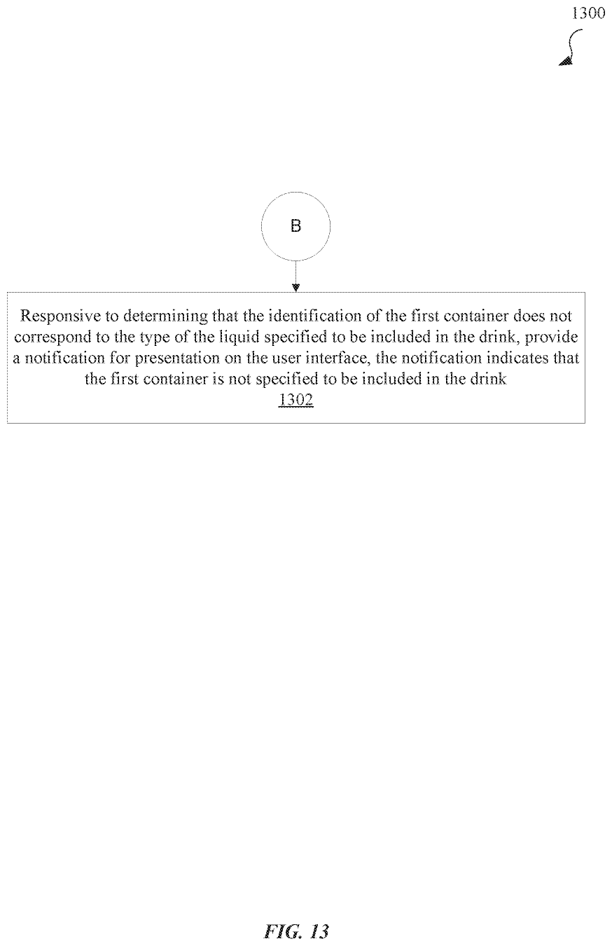

FIG. 14 shows a computer system in accordance with various embodiments.

### DEFINITIONS

Certain terms are used throughout the following description and claims to refer to particular hardware and software components. As one skilled in the art will appreciate, different companies may refer to components by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

In the following discussion, recipes are described as specifying weights of liquid in ounce-forces (referred to as “ounces”); however, it should be understood that recipes typically specify a volume of liquid in fluid-ounces and the fluid-ounces specified in the recipes may be converted to ounces described below.

The terms “real-time” or “near real-time” may refer to performing an action (e.g., displaying an amount of liquid added to a container, displaying a notification, etc.) within two seconds or less.

### DETAILED DESCRIPTION

The following discussion is directed to various embodiments of the disclosed subject matter. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Entities that sell beverages, such as restaurants, bars, food trucks, and the like, often buy bottles (containers) of individual liquids and/or premixed liquids (e.g., a bottle of premixed margarita). The entities may employ a bartender, for example, whose job function is to make beverages that are ordered by customers. Oftentimes, a customer orders a beverage, such as a margarita, and there is a recipe associated with that beverage. The recipe may specify mixing 2 ounces of tequila brand X, 2 ounces of triple sec brand X, 3 ounces of lime juice, etc. Entities may lose a lot of money by bartenders not following the recipe exactly and over-pouring the various portions of liquid called for in the recipe. For example, some bartenders pour more liquor into drinks for friends or patrons that tip well. Sometimes, bartenders may give out free shots of liquor. Sometimes, bartenders may perform tricks to impress customers and flip bottles in the air. Such tricks are not always successful and bottles may break. Conventional inventory control techniques do not adequately account for the amount of liquid that is in stock at the entities. As such, entities lose money by having to buy more bottles of liquids more frequently than they should.

Accordingly, at least some of the example embodiments are directed to a method and system of weight-based portion inventory control in mixology of beverages. For example, a customer may order a beverage, such as a mixed drink (e.g., margarita). The techniques may include presenting a recipe for the mixed drink on a computing device. The recipe may specify the types of liquid to be mixed for the drink and amounts of the liquid in weight (e.g., ounces) to be used in the drink. The techniques may include tracking the amount of liquid in the bottle based on a weight of the bottle at a first weigh scale at a storage station (e.g., shelf, countertop, etc.). There may be separate respective weigh scales for different respective bottles of liquid. The weigh scales may be communicatively coupled with one or more computing devices (e.g., a computing device at a mixing station, a server, etc.). Further, each storage station may include a reader capable of detecting an identification mechanism of the bottle located at the storage station. The techniques may enable detecting when the bartender picks up the right or wrong bottle of liquid for a certain recipe. Also, the techniques may also enable detecting when the bartender places the right or wrong bottle of liquid at a storage station.

A mixing station may also include a weigh scale. A bartender may fill a cocktail shaker with ice and/or other items and place the cocktail shaker on the weigh scale at the mixing station. The bartender may obtain a tare weight of the scale supporting the cocktail shaker including its contents prior to adding the liquids. A tare weight may refer to setting the weigh scale to zero when a load is applied to the weigh scale. Once the weigh scale is tared, the bartender may pour the appropriate liquid out of a bottle into the cocktail shaker. The techniques may enable presenting the amount of weight of the liquid added to the cocktail shaker in real-time as the bartender pours the liquid into the cocktail shaker. A computing device may indicate when the proper amount of liquid is added to the cocktail shaker.

The bartender may place the bottle of liquid back on a weigh scale at its storage station. The amount of weight of the liquid added to the cocktail shaker and an amount of weight of the liquid removed from the bottle may be compared to a target weight (e.g., 2 ounces). If the added weight and removed weight match the target weight, the bartender successfully followed the recipe. If the added weight and removed weight do not match the target weight, then the bartender may have poured too little liquid or too much liquid. Further, if the added weight and removed weight do not match each other, then the bartender may have diverted the liquid into another container that was not placed on the weigh scale at the mixing station. In such scenarios, notifications may be presented on a computing device and/or alerts may be triggered to indicate that the recipe was not properly followed and/or to provide an explanation of any discrepancies. It should be noted that “matching” may refer to the added weight and the removed weight exactly matching or substantially matching within a threshold acceptable range (e.g., from 0 ounces to 0.3 ounces).

In some embodiments, a customer may request an extra amount of the liquid. The request may be received before the bartender begins adding the liquid to the cocktail shaker. In such an instance, the bartender may update the order at the mixing station, and the system may determine a new target weight based on the requested extra amount of the liquid. Further, the sales price for the beverage may be adjusted according to the extra amount of liquid. Correlations of certain amounts of liquids (e.g., a shot of tequila) and their respective sales prices (e.g., $5) may be maintained by the system, and the system may calculate the updated sales price of the beverage based on the extra amount of liquid requested. Further, the display may present the new target weight for the requested liquid.

In some instances, the request may be received after the bartender has already added some liquid to the cocktail shaker. In such an instance, the bartender may stop adding the liquid to the cocktail shaker, and update the order to add the extra requested liquid at the mixing station. In some embodiments, when the user has ordered a mixed drink having specific proportions of liquids in a recipe, the system may account for the other amounts of liquids in the beverage that result from adding the extra requested liquid. The system may determine the new target weights for each liquid in the recipe. To that end, the system may account for the added weight of a particular liquid already included in the cocktail shaker when determining the new target weights. The system may update the sales price of the beverage based on liquids to be added and may present the new target weights for each ingredient when those respective ingredients are to be added.

After each ingredient is added to the cocktail shaker, the weigh scale at the mixing station may be calibrated back to a tare weight so an accurate weight measurement of the next ingredient may be measured. For example, if the weight stops increasing at the mixing station, and the bottle is placed in its proper location, then the system may reset by calibrating the weigh scale at the mixing station back to the tare weight to prepare for the next ingredient. The bartender may follow this process until every ingredient called for in the recipe is added to the cocktail shaker. Using the disclosed techniques to manage inventory using weight-based portion control may enable an entity to obtain the proper revenue from their bottles of liquid and make higher profits.

The granular level of tracking and managing the amount of liquid in each bottle and tracking the weight of the liquid distributed and retained in inventory may enable an entity selling the beverages including the liquid to determine exactly how much profit is made and how much liquid is left in the inventory. Using historical usage patterns of an amount in weight of liquid that is consumed over certain time periods (e.g., holidays) may enable the system to predict and recommend having a certain amount in weight of liquid in the inventory for those time periods in the future.

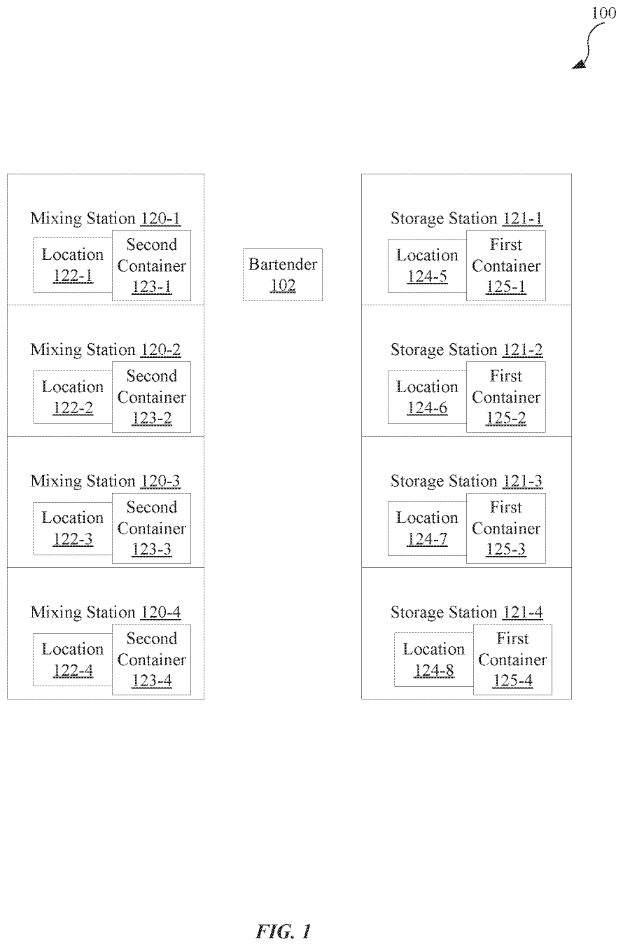

Turning now to the Figures, FIG. 1 shows an overhead view of a bar using an example system 100 in accordance with various embodiments. The bar may be in a restaurant, a sports bar, a hotel, a theater, an airplane, a vehicle, or any suitable location that distributes liquid. As depicted, the bar may include one or more mixing stations 120 (e.g., 120-1 through 120-4), and one or more storage stations 121 (e.g., 121-1 through 121-4). A bartender 102 may be employed by an entity owning the bar.

Each of the storage stations 121 may include a location 124 (e.g., 124-1 through 124-4), each having a respective weigh scale. The weigh scale may be installed or located on top of a tabletop, shelf, or the like. A first container 125 (e.g., 125-1 through 125-4) may be placed on a weigh scale at each of the locations 124. The first containers 125 may be bottles of liquid, such as liquor bottles, wine bottles, beer bottles, water bottles, soft drink bottles, etc. The weigh scales may measure the weight of the container containing the liquid. An initial container weight may be obtained when the container of liquid is initially placed on the weigh scale. In some embodiments, for bottles include a dispensing device, the initial container weight may include the weight of the dispensing device.

In some embodiments, each location 124 may also include a tracking mechanism (e.g., barcode reader, near-field communication, or RFID chip reader) that obtains (e.g., reads, scans, etc.) an identifier of the identification mechanism of the first container 125. The identifier may be used to determine when the right or wrong first container is selected for a particular recipe of a beverage. A recipe may include one or more ingredients specifying different liquids and an amount of weight of the liquid to be added to make a beverage. For example, one recipe may specify mixing 2 ounces of tequila, 2 ounces of triple sec, and 2 ounces of lime juice to make a margarita. Another recipe may specify pouring 4 ounces of wine. Further, the identifier may be used to ensure the proper first containers 125 are disposed at the proper storage stations 121.

Each mixing stations 120 may include a location 122 (e.g., 122-1 through 122-4), each having a respective weigh scale. The weigh scale may be installed or located on top of a tabletop, shelf, standalone device, or the like. A second container 123 (e.g., 123-1 through 123-4) may be placed on a weigh scale at each of the locations 122. The second containers 123 may be cocktail shakers, cups, bowls, or any suitable container capable of holding liquid. The weigh scales may measure the weight of the container. An initial container weight may be obtained when the second container is initially placed on the weigh scale. The weigh scale may be tared to calibrate the weigh scale at zero when the second container 123 is disposed on the weigh scale. For example, the second container may include ice, and the weight of the second container and the ice may be subtracted so that just the added weight of the liquid may be measured. Such a technique may enable measuring an accurate weight of liquid as it is being add to the second container 123.

In some embodiments, each location 122 may also include a tracking mechanism (e.g., barcode reader, near-field communication, or RFID chip reader) that obtains (e.g., reads, scans, etc.) an identifier of the identification mechanism of the first container 125. The identifier may be used to determine when the right or wrong first container is being used for a particular recipe of a beverage.

In some embodiments, a computing device is located at one or more of the mixing stations 120. The computing device may be a tablet, a laptop, a computer, a smartphone, or the like. In some embodiments, the computing device may be integrally included in a device also including the weigh scale. The computing device may present a user interface on display screen. The user interface may provide options for various beverages that a customer may order. When a beverage order is received, the user interface may present the recipe including various ingredients and the amounts of weights of the ingredients to add. The user interface may present instructions of an order in which to add the ingredients to the second container 123.

The weigh scales at the storage station 121 and/or the mixing station 120 may provide continuous, near continuous, or periodic weight measurements to the computing device located at the mixing station 120 and/or a server computing device. The computing device and/or the server computing device may track the weight of the liquid added to the second container 123 as it is being added and present the weight in real-time on a user interface of the computing device. The user interface may instruct the bartender 102 to add more liquid, stop adding liquid when the proper weight of liquid is added, and/or indicate that too much liquid has been added, among other things.

When the bartender 102 places the first container 125 back on the weigh scale at the storage station 121, the weigh scale at the storage station 121 may weigh the first container 125 and transmit a subsequent weight to the computing device and/or the server computing device. The computing device and/or the server computing device may determine a reduced weight of the liquid in the first container 125 based on the initial weight of the first container 125 and the subsequent weight. The reduced weight of the liquid in the first container and the added weight of the liquid to the second container may be compared to determine whether they match a target weight (e.g., 2 ounces). If the reduced weight and the target weight match, the proper amount of liquid was poured out of the first container 125 and into the second container 123. If the reduced weight and the target weight do not match the target weight, then either too little liquid or too much liquid was added to the second container 123. Further, the reduced weight and the added weight may be compared to each other. If the reduced weight and the added weight differ, then the bartender may have added another ingredient to the second container 123 without taring the weigh scale, the bartender may have poured the liquid out of the first container 125 into another container besides the second container 123, or the like. In any scenario, a notification may be presented on the user interface of the computing device indicating relevant details, as disclosed further below.

Each mixing station 120 may include an alarm that is activated when various scenarios are detected or occur. For example, the alarm may be activated when the added weight and the removed weight do not match the target weight, when the added weight and the removed weight do not match each other, when a wrong first container is picked up from the storage station 121, when a wrong first container is detected at the mixing station 120, and the like.

The user interface may walk the bartender 102 through the process of adding the ingredients until every ingredient is added to the second container 123. Upon completion, the user interface may instruct the bartender 102 to shake the second container 123 or stir the contents of the second container 123 based on the recipe or input from the customer. The beverage may be served to the customer.

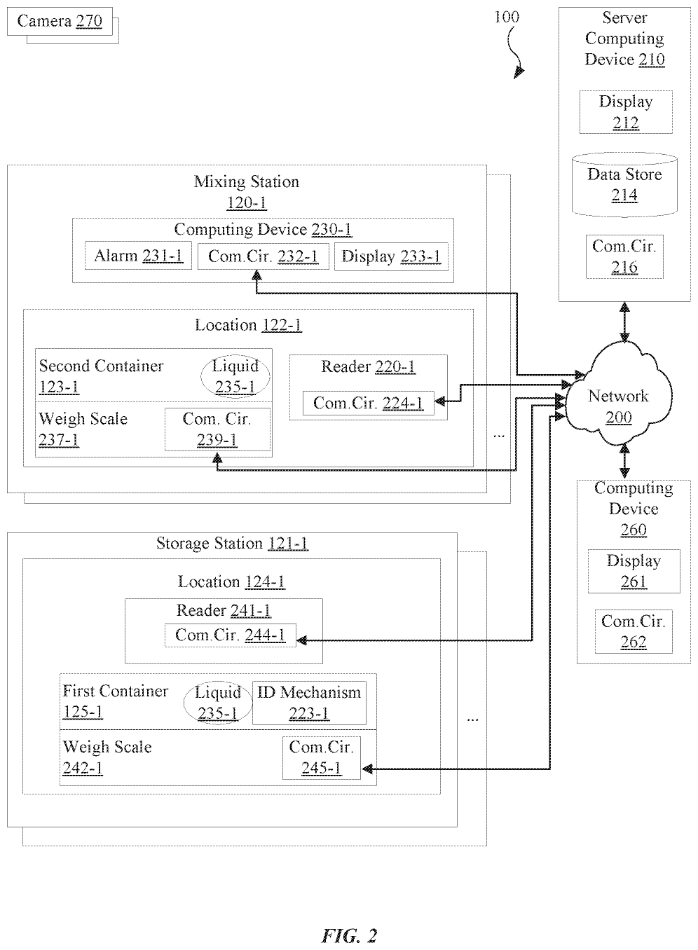

FIG. 2 shows an example component diagram of the system 100 in accordance with various embodiments. As depicted, the system 100 includes a network 200 to which various components of the mixing stations (e.g., 120-1 through 120-4), various components of the storage stations 121 (e.g., 121-1 through 121-4), a server computing device 210, a computing device 260, and/or a camera 270 (connection not shown) are connected. The network 200 may include a public network (e.g., connected to the Internet via wired (Ethernet) or wireless (WiFi)), a private network (e.g., a local area network (LAN) or wide area network (WAN)), or a combination thereof. The various electronic devices may transmit data to and receive data from each other via the network 200.

The system 100 includes the server computing device 210. Although one server computing device 210 is depicted, numerous server computing devices 210 may be included in the system 100 and communicably coupled with each other via the network 200. Each of the servers 210 may include one or more displays 212, processing devices, memory devices, data stores 214, and/or communication circuitry 216. The data store 214 may store an inventory of first containers 125 of liquid, amounts of weight of the liquid in each of the first containers 125, recipes, and so forth. The data store 214 may also store the number of different storage stations 121 and/or mixing stations 120 that are operational at any given time, the type of liquid included in the first containers 125, a minimum acceptable weight for each type of liquid at each first container 125, and so forth. In addition, the data store 214 may store an association of an identifier of a type of liquid in each first container 125, the types and amounts of liquid that are specified by each recipe, and so forth.

The system 100 includes the mixing station 120-1. The mixing station 120-1 includes various components, such as a computing device 230-1, a reader 220, a second container 123-1, and/or a weigh scale 237-1. The second container 123-1 may be disposed on the weigh scale 237-1. The weigh scale 237-1 may be any suitable weigh scale capable of measuring a weight of the second container 123-1 including liquid 235-1. The weigh scale 237-1 may include a processing device and/or a memory device. The weigh scale 237-1 may be a precision scale that provides one or more digital readouts via a light emitting diode display (not shown). The weigh scale 237-1 may include materials that render the weigh scale 237-1 waterproof, temperature (e.g., hot, cold) resistant, or some combination thereof. The weigh scale 237-1 may include communication circuitry 239-1. The communication circuitry 239-1 may include a network interface and enable communicating data with other electronic devices over the network 200. For example, the weigh scale 237-1 may transmit measured weights of the container 236-1 to the computing device 230-1, the server computing device 210, and/or the computing device 260 over the network 200 via the communication circuitry 239-1.

The reader 220-1 may be a tracking mechanism (not shown) that includes a scanner (e.g., barcode, serial number, etc.), a radio-frequency identification (RFID) reader, or the like. The reader 220-1 may be any suitable reader that is capable of obtaining an identifier of an identification mechanism 223-1 of the first container 125-1. To that end, the identification may be any suitable identification mechanism 223-1 that is capable of including an identifier and being read by the reader 220-1. The identification mechanism 223-1 may be disposed on a side, bottom, or top of the first container 125-1 to enable the identification mechanism 223-1 to be read when the first container 125-1 is located near the reader 220-1.

The reader 220 may further include communication circuitry 224-1 that enables communicating data with other electronic devices over the network 200. For example, the communication circuitry 224-1 may include a network interface that enables communication via a wireless protocol for transmitting data over short distances, such as Bluetooth, ZigBee, etc. and/or a wireless protocol for communicating data over long distances, such as WiFi. The reader 220-1 may include a processing device and/or memory device, as well as any other suitable component.

The computing device 230-1 includes a display 233-1 and communication circuitry 232-1. The computing device 230-1 may also include a processing device and/or memory device, as well as any other suitable component. The communication circuitry 232-1 may include a network interface and enable communicating data with other electronic devices over the network 200. The display 233-1 may present a user interface that displays one or more indications, alerts, messages, notifications, or the like. For example, the user interface on the display 233-1 may present information pertaining to a beverage ordered by a customer, ingredients (e.g., type of liquid, brand of liquid, etc.) included in a recipe for the beverage, amount of weight of the ingredients to use, and so forth. The display 233-1 may be a touchscreen and/or the computing device may include any suitable input peripheral to enable a user to interact with an application running on the computing device 230-1.

The computing device 230-1 may also include an alarm 231-1. The alarm 231-1 may include a light capable of emitting various colors of light based on the type of alert, a speaker capable of emitting various audible sounds based on the type of alert, or some combination thereof. For example, the alarm 231-1 may be activated (e.g., flash a color of light, make an audible sound, or both) when it is determined that the added weight of the liquid 235-1 to the second container 123-1 and the removed weight of the liquid 235-1 from the first container 125-1 does not match a target weight and/or each other. The alarm 231-1 may be activated when the wrong first container 125-1 is picked up by the bartender 102 at the first container 125-1 and/or the wrong first container 125-1 is detected at the mixing station 120-1.

The storage station 121-1 may include a reader 241-1 and a weigh scale 242-1 at a location 124-1. The first container 125-1 may be disposed on the weigh scale 242-1. The weigh scale 242-1 may be any suitable weigh scale capable of measuring a weight of the first container 125-1 including liquid 235-1. The weigh scale 242-1 may include a processing device and/or a memory device. The weigh scale 242-1 may be a precision scale that provides one or more digital readouts via a light emitting diode display (not shown). The weigh scale 242-1 may include materials that render the weigh scale 242-1 waterproof, temperature (e.g., hot, cold) resistant, or some combination thereof. The weigh scale 242-1 may include communication circuitry 245-1. The communication circuitry 25-1 may include a network interface and enable communicating data with other electronic devices over the network 200. For example, the weigh scale 242-1 may transmit measured weights of the first container 125-1 to the computing device 230-1, the server computing device 210, and/or the computing device 260 over the network 200 via the communication circuitry 245-1.

The reader 241-1 may be a tracking mechanism (not shown) that includes a scanner (e.g., barcode, serial number, etc.), a radio-frequency identification (RFID) reader, or the like. The reader 241-1 may be any suitable reader that is capable of obtaining an identifier of the identification mechanism 223-1 of the first container 125-1. To that end, the identification may be any suitable identification mechanism 223-1 that is capable of including an identifier and being read by the reader 241-1. The identification mechanism 223-1 may be disposed on a side, bottom, or top of the first container 125-1 to enable the identification mechanism 223-1 to be read when the first container 125-1 is located near the reader 220-1.

The reader 241-1 may further include communication circuitry 244-1 that enables communicating data with other electronic devices over the network 200. For example, the communication circuitry 244-1 may include a network interface that enables communication via a wireless protocol for transmitting data over short distances, such as Bluetooth, ZigBee, etc. and/or a wireless protocol for communicating data over long distances, such as WiFi. The reader 241-1 may include a processing device and/or memory device, as well as any other suitable component.

An employee may use the computing device 260 to facilitate management of the bar. For example, the employee may use the computing device to provide instructions to the server computing device 210 and/or the computing device 230-1. In some embodiments, the computing device 260 may include a smartphone, tablet, laptop, desktop, or the like. The computing device 260 may include a display 261 and communication circuitry 262. The communication circuitry 262 may include a network interface and enable communicating data with other electronic devices over the network 200. For example, the communication circuitry 262 may receive information from the server computing device 210. The information may relate to the inventory of first containers 125 of liquid that are owned by the bar, to the types of liquid available at each storage station 121-1, historical information pertaining to amounts (e.g., weighs) and types of liquid used and time periods when those amounts and types of liquid were used, an amount of money the restaurant has made for any suitable time period, and so forth. The information may be displayed on a user interface of the display 261.

The camera 270 may be any suitable camera capable of obtaining video or image data. The camera 270 may provide the video and/or image data to the server computing device 210, the computing device 230-1, and/or the computing device 260. The video and/or image data may be used when alarm 231 is activated to determine where missing weights of liquid went when there is removed weight of liquid from the first containers 125-1 with no corresponding added weight of the liquid to the second containers 123. The video and/or image data may be used to identify the bartender that making the beverages using the mixing station 120-1. In some embodiments, object recognition software may be used to identify the type of first container 125 picked up by a bartender and used to make a beverage. For example, a processing device may process video data to determine that the bartender is using the right or wrong type of liquid for a recipe based on the type of first container 125 identified.

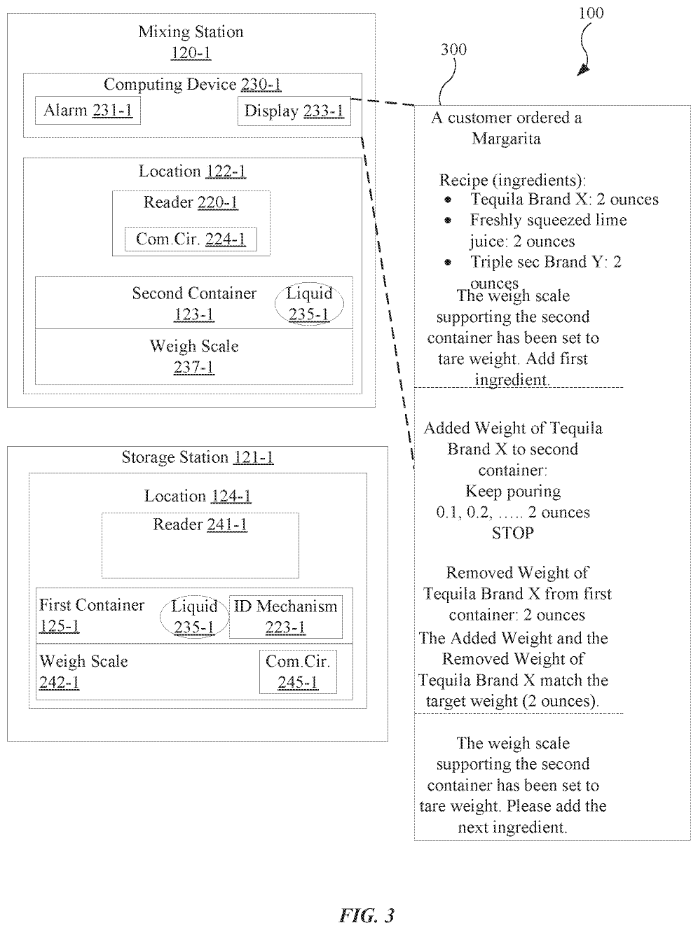

FIG. 3 show an example transfer of liquid from a storage location to a mixing station using the system in accordance with various embodiments. As depicted, the storage station 121-1 includes the first container 125-1 containing the liquid 235-1, and the first container 125-1 is disposed on the weigh scale 242-1. A processing device (e.g., of the computing device 230-1, the server computing device 210, and/or the computing device 260) may obtain an initial container weight of the first container 125-1 when the first container 125-1 including the liquid 235-1 is initially disposed on the weigh scale 242-1. The initial container weight may be stored in a data store of the computing device 230-1, the data store 214 of the server computing device 210, and/or a data store of the computing device 260.

A customer may have ordered a beverage (e.g., margarita). The computing device 230-1 may receive the order via input by the bartender 102, electronic transmission by an application running on a computing device of the customer or the bar, or the like. A user interface 300 may present a recipe pertaining to the margarita. As depicted, the user interface 300 presents the recipe as including tequila brand X (3 ounces), freshly squeezed lime juice (2 ounces), triple sec brand y (2 ounces).

The bartender 102 may pick up the second container 123-1 (cocktail shaker) and add ice to the second container 123-1. The bartender 102 may place the second container 123-1 on the weigh scale 237-1 at the mixing station 120-1. The weigh scale 237-1 may detect that the second container 123-1 is placed on the weigh scale 237-1 and automatically calibrate the tare weight to zero if the processing device determines the first ingredient has not been added yet. In some embodiments, the bartender 102 may make a selection to calibrate the tare weight to zero using an input mechanism of the computing device 230-1. The user interface 300 may indicate “The weigh scale supporting the second container has been set to tare weight. Add first ingredient.”

The bartender 102 may lift up the first container 125-1 that contains liquid 235-1 of tequila brand X. The reader 241-1 may read the ID mechanism 223-1 of the first container 125-1 and transmit the identifier associated with the ID mechanism 223-1 to the computing device 230-1 and/or the server computing device 210. The computing device 230-1 and/or the server computing device 210 may determine whether the correct first container 125-1 of liquid 235-1 was selected for the recipe based on the received identifier. In the depicted example, the correct first container 125-1 was selected.

The bartender 102 may carry the first container 125-1 over to the mixing station 120-1. The reader 220-1 at the mixing station 120-1 may read the ID mechanism 223-1 of the first container 125-1 and transmit the identifier associated with the ID mechanism 223-1 to the computing device 230-1 and/or the server computing device 210. The computing device 230-1 and/or the server computing device 210 may determine whether the correct first container 125-1 of liquid 235-1 was selected for the recipe based on the received identifier. In other cases, the computing device 230-1 may omit the reading the first container 125-1 and assume the liquid being poured is the correct liquid based on removal of the correct first container 125-1 from its storage station 121-1. In the depicted example, the correct first container 125-1 was selected.

The bartender 102 may begin pouring the liquid 235-1 out of the first container 125-1 and into the second container 123-1. The weigh scale 237-1 may weigh the second container 123-1 as the liquid 235-1 is added and transmit the added weight of the liquid 235-1 in real-time or near real-time to the computing device 230-1 and/or the server computing device 210. The computing device 230-1 may present the added weight the liquid 235-1 in real-time or near real-time via the user interface 300 as the liquid 235-1 is added to the second container 123-1. As depicted, the user interface 300 indicates “Added weight of tequila brand X to second container:” and a statement “Keep pouring” as the added weight increases from 0.1 to 0.2 to 2 ounces. When the computing device 230-1 determines the target weight (2 ounces) for the tequila brand X specified in the recipe has been added to the second container 123-1, the user interface 300 may present an indication “STOP” or something similar to indicate that the target weight of the liquid 235-1 has been added to the second container 123-1.

The bartender 102 may stop pouring and return the first container 125-1 to the weigh scale 242-1. The reader 241-1 may read the ID mechanism 223-1 again and transmit the identifier associated with the ID mechanism 223-1 to the computing device 230-1 and/or the server computing device 210. The computing device 230-1 and/or the server computing device 210 may determine whether the correct first container 125-1 has been returned to the correct storage location 124-1. In the depicted example, the correct first container 125-1 was returned to the correct storage location 124-1.

The weigh scale 242-1 may weigh the first container 125-1 when it is returned and transmit a subsequent weight to the computing device 230-1 and/or the server computing device 210. The computing device 230-1 and/or the server computing device 210 may determine a removed weight of the liquid 235-1 from the first container 125-1 by subtracting the subsequent weight from the initial weight of the first container 125-1. As depicted, the user interface 300 may present an indication “Removed weight of tequila brand X from first container: 2 ounces”. The computing device 230-1 and/or the server computing device 210 may determine whether the added weight of the liquid to the second container 123-1 and the removed weight of the liquid 235-1 from the first container 125-1 match a target weight (e.g., 2 ounces). In the depicted example the removed weight and the added weight match, and the user interface 300 may present an indication “The added weight and the removed weight of tequila brand X match the target weight (2 ounces)”.

The weigh scale 237-1 may be calibrated to the tare weight again after the first ingredient is added. The user interface 300 may further present an indication “The weigh scale supporting the second container has been set to tare weight. Please add the next ingredient.” The bartender may select another first container 125-2 specified by the recipe and the process may continue until the margarita is made.

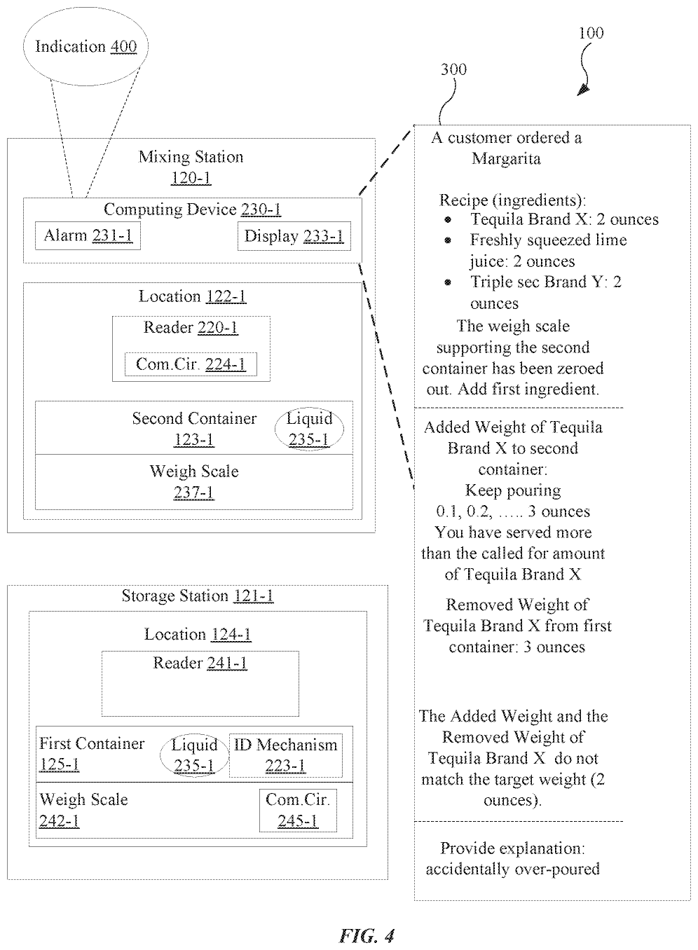

FIG. 4 shows an example of detecting that too much of a liquid was poured in accordance with various embodiments. As depicted, a user interface 300 is presented on the display 233-1 of the computing device 230-1. The depicted example relates also relates to a customer ordering a margarita. Accordingly, the recipe for a margarita is presented on the user interface 300 and an indication that the second container 123-1 has been calibrated to the tare weight is also presented. The bartender 102 and/or the various electronic components of the system 100 may perform similar steps as described above with reference to FIG. 3. As depicted in FIG. 4, the bartender 102 is pouring the liquid 235-1 into the second container 123-1 and the user interface 300 is presenting the added weight of the liquid 235-1 in real-time or near real-time. However, in FIG. 4, the bartender 102 may have gotten distracted or deliberately poured too much liquid 235-1 (3 ounces) into the second container 123-1. The computing device 230-1 and/or the server computing device 210 may make this determination based on the target weight of the liquid 235-1 specified in the recipe and the measured added weight of the liquid 235-1 to the second container 123-1. Accordingly, the user interface 300 presents an indication “You have served more than the called for amount of tequila brand X.” The computing device 230-1 may trigger the alarm to provide an indication 400 indicating the same.

The bartender 102 may return the first container 125-1 to the weigh scale 242-1 for a subsequent measurement of the first container 125-1 to be transmitted to the computing device 230-1 and/or the server computing device 210. The computing device 230-1 and/or the server computing device 210 may determine the reduced weight (3 ounces) of the liquid in the first container 125-1. The reduced weight (3 ounces) and the added weight (3 ounces) of the liquid 235-1 may be compared with the target weight (2 ounces), and the computing device 230-1 and/or the server computing device 210 may determine that the reduced weight and the added weight do not match the target weight. Accordingly, a notification may be presented “The added weight and the removed weight of tequila brand X do not match the target weight (2 ounces)”. The computing device 230-1 may trigger the alarm to provide an indication 400 indicating the same. Further, the user interface 300 may provide a prompt for the bartender 102 to input an explanation for the over-pour (e.g., “accidentally over-poured”).

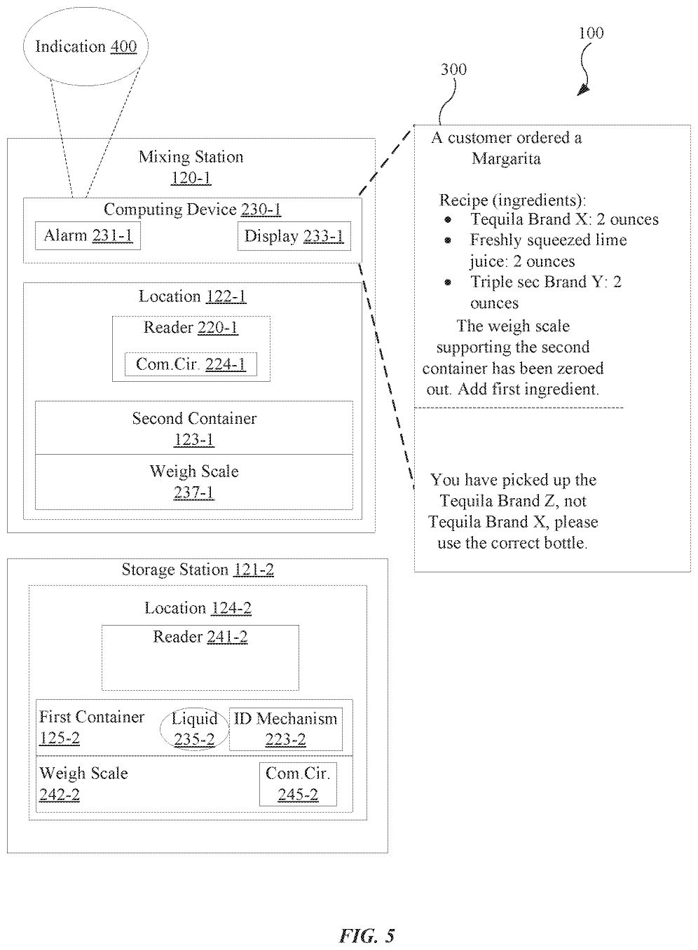

FIG. 5 shows an example of detecting that the wrong container of liquid was picked up by a bartender in accordance with various embodiments. The depicted example relates to the customer ordering the margarita. In the depicted example, the bartender 102 may lift up a first container 125-2 at another storage station 121-2. The first container 125-2 may include tequila brand Y liquid 235-2 and not tequila brand X liquid. The reader 241-2 may read the ID mechanism 223-2 of the first container 125-2 and transmit the identifier associated with the ID mechanism 223-2 to the computing device 230-1 and/or the server computing device 210. The computing device 230-1 and/or the server computing device 210 may determine the identifier is for the wrong type of liquid. Accordingly, the user interface 300 may present a notification “You have picked up the tequila brand Z, not tequila brand X, please use the correct bottle”. The alarm 231-1 may be triggered to provide indication 400 indicating the same.

In some embodiments, the computing device 230-1 and/or the server computing device 210 may receive a weight measurement from an incorrect storage station 121-2 where an incorrect first 121-2 is picked up by the bartender 102. For example, the weight measurement may be zero and the computing device 230-1 and/or the server computing device 210 may determine that the bartender has selected the wrong first container 125-2 and present a notification indicating the same.

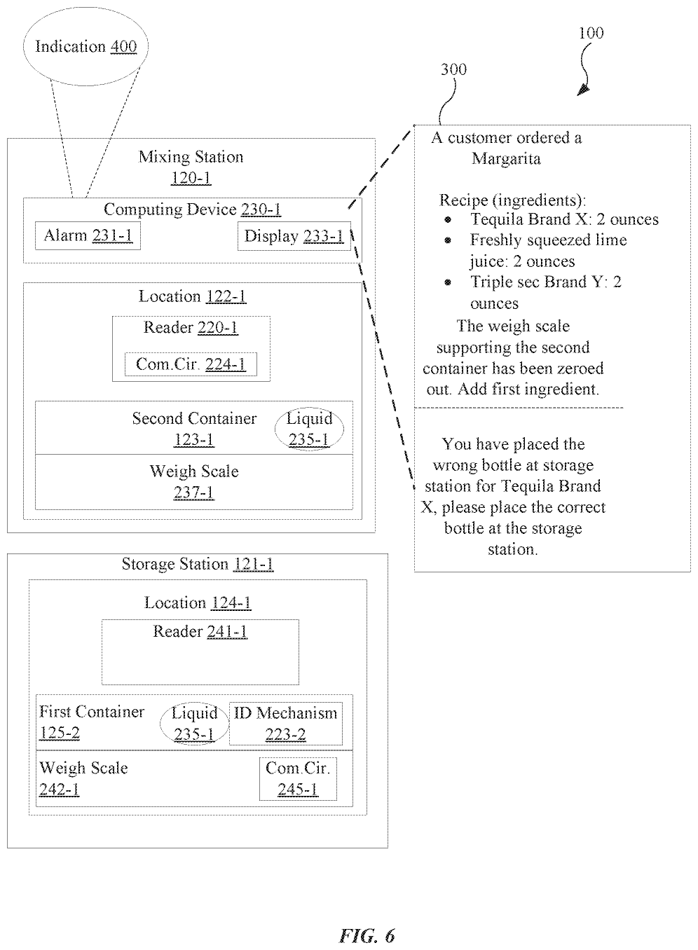

FIG. 6 shows an example of detecting that the wrong container of liquid is placed at a storage location in accordance with various embodiments. The depicted example relates to the customer ordering the margarita. In the depicted example, the bartender 102 may have placed the wrong first container 125-2 at the storage station 121-1. The first container 125-2 may include tequila brand Y liquid 235-2 and not tequila brand X liquid which is associated with the storage station 121-1. The reader 241-1 may read the ID mechanism 223-2 of the first container 125-2 and transmit the identifier associated with the ID mechanism 223-2 to the computing device 230-1 and/or the server computing device 210. The computing device 230-1 and/or the server computing device 210 may determine the identifier is for the wrong type of liquid associated with the storage station 121-1. Accordingly, the user interface 300 may present a notification “You have placed the wrong bottle at storage station for tequila brand X, please place the correct bottle at the storage station”. The alarm 231-1 may be triggered to provide indication 400 indicating the same.

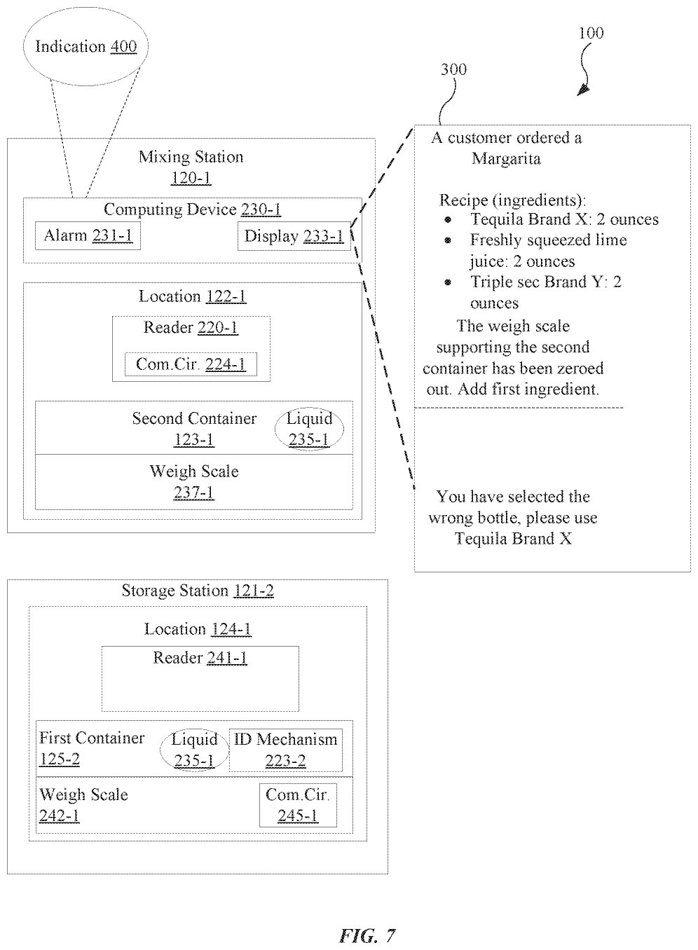

FIG. 7 shows an example of detecting that the wrong container of liquid is scanned at the mixing station in accordance with various embodiments. The depicted example relates to the customer ordering the margarita. In the depicted example, the bartender 102 may have picked up the wrong first container 125-2 at the storage station 121-2. The first container 125-2 may include tequila brand Y liquid 235-2 and not tequila brand X liquid, which is specified as an ingredient in the recipe presented on the user interface 300. Prior to the bartender 102 pouring an ingredient, the reader 220-1 at the mixing station may read the ID mechanism 223-2 and transmit the identifier associated with the ID mechanism 223-2 to the computing device 230-1 and/or the server computing device 210. The computing device 230-1 and/or the server computing device 210 may determine the identifier is for the wrong type of liquid specified in the recipe for the margarita. Accordingly, the user interface 300 may present a notification “You have selected the wrong bottle, please use tequila brand X”. The alarm 231-1 may be triggered to provide indication 400 indicating the same.

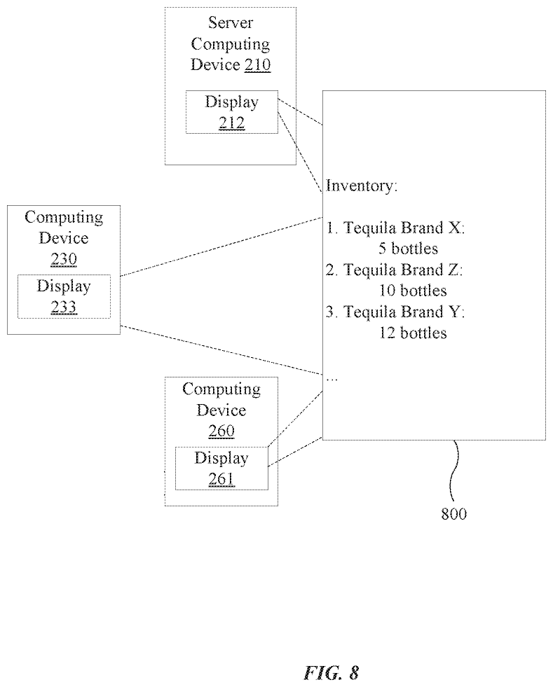

FIG. 8 shows an example user interface 800 presenting a weight-based inventory of liquids in accordance with various embodiments. As depicted, the user interface 800 may be presented by the display 212 of the server computing device 210, the display 233 of the computing device 230, and/or the display 261 of the computing device 260. The user interface 800 may present an amount of bottles of each type of liquid owned by an entity and present the amount of bottles of each type of liquid. For example, the user interface 800 presents the inventory currently includes 5 bottles of tequila brand X, 10 bottles of tequila brand Z, and 12 bottles of tequila brand Y. It should be noted that a processing device may receive the weight measurements of first containers 125 (bottles) from weigh scales 242-1 at storage stations 121-1. The weight measurements may be in ounces, and the processing device may convert the ounces to a unit of volume, such as fluid ounces. The processing device may determine how many bottles of each of liquid are in-stock based on the fluid ounces.

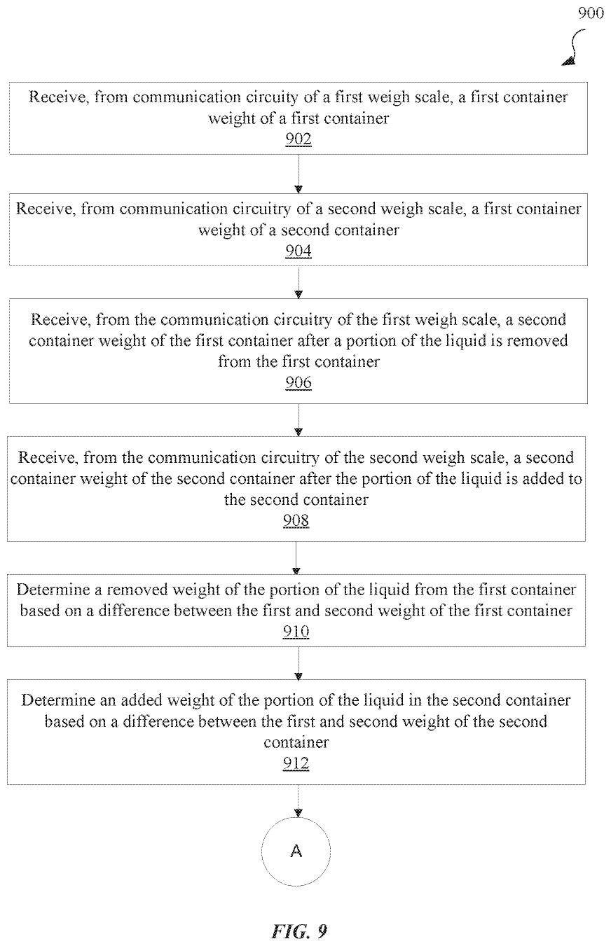

FIG. 9 shows a method 900 in accordance with various embodiments. The method 900 may be performed by processing logic that may include hardware (circuitry, dedicated logic, etc.), firmware, software, or a combination of both. The method 900 may establish initial weights for each of the respective first containers 125 at the storage stations 121. The following description relates to the first mixing station 120-1 but the method 900 may be performed for each of the mixing stations 120. The method 900 and/or each of their individual functions, subroutines, or operations may be performed by one or more processors of a computing device (e.g., computing device 230, server computing device 210, computing device 260, computing device 260, etc.) implementing the method 900. The method 900 may be implemented as computer instructions that are executable by a processing device. In certain implementations, the method 900 may be performed by a single processing thread. Alternatively, the method 900 may be performed by two or more processing threads, each thread implementing one or more individual functions, routines, subroutines, or operations of the methods. In some embodiments, the operations of the method 900 may be performed by the computing device 230.

At block 902, the processing device receives, from communication circuitry 245-1 of a first weigh scale 242-1, a first container weight of a first container 125-1 (e.g., bottle of liquid). The first container 125-1 is disposed on the weigh scale 242-1 at a container station (e.g., storage station 121-1). The processing device may also receive an identifier of the first container 125-1 from a reader 241-1 that reads the ID mechanism 223-1 and sends the identifier to the processing device. At block 904, the processing device receives, from communication circuitry 239-1 of a second weigh scale 237-1, a first container weight of a second container 123-1 (e.g., cocktail shaker, cup).

At block 906, the processing device may receive, from the communication circuitry 245-1 of the first weigh scale 242-1, a second container weight of the first container 125-1 after a portion of the liquid 235-1 is removed from the first container 125-1. For example, when the first container 125-1 is placed back on the first weigh scale 242-1 after liquid is poured out of the first container 125-1 in to the second container 123-1. At block 908, the processing device may receive, from the communication circuitry 239-1 of the second weigh scale 237-1, a second container weight of the second container 123-1 after a portion of the liquid 235-1 is added to the second container 123-1.

At block 910, the processing device may determine a removed weight of the portion of the liquid 235-1 from the first container 125-1 based on a difference between the first and second weight of the first container 125-1. At block 912, the processing device may determine an added weight of the portion of the liquid 235-1 in the second container 123-1 based on a difference between the first and the second weight of the second container 123-1. The processing device may present an indication of the added weight of the portion of the liquid 235-1 on the user interface of the computing device 230-1 in real-time or near real-time while the portion of the liquid is being added to the second container 123-1.

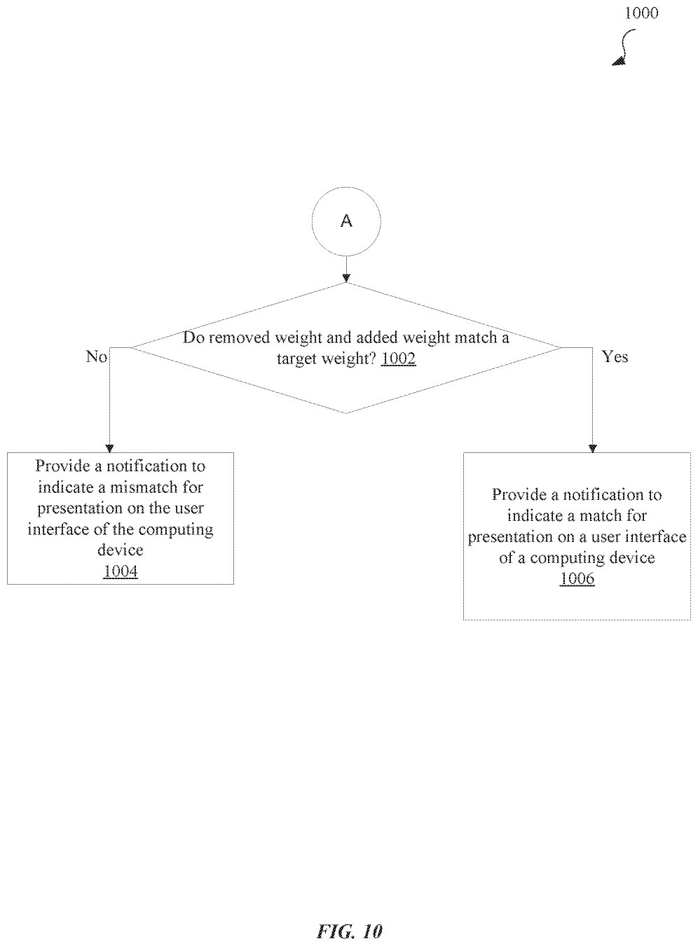

FIG. 10 shows a method 1000 in accordance with various embodiments. Method 1000 includes operations performed by processing devices of a computing system (e.g., computing device 230, server computing device 210, computing device 260, etc.) implementing the method 1000. In some embodiments, one or more operations of the method 1000 are implemented in computer instructions that are executable by a processing device. In some embodiments, the operations of the method 1000 may be performed by the computing device 230. The method 1000 may be performed in the same or a similar manner as described above in regards to method 900. The method 1000 may begin at block 1002 and include additional operations to the method 900 in FIG. 9.

At block 1002, the processing device determines whether the removed weight and the added weight match a target weight. The target weight may be specified in a recipe for a beverage ordered by a customer. At block 1004, the processing device determines whether the removed weight and added weight match a target weight. If not, the processing device provides, at block 1004, a notification to indicate a mismatch for presentation on the user interface of the computing device 230-1. If the removed weight and added weight match, the processing device provides, at block 1006, a notification to indicate a match for presentation on a user interface of the computing device 230-1.

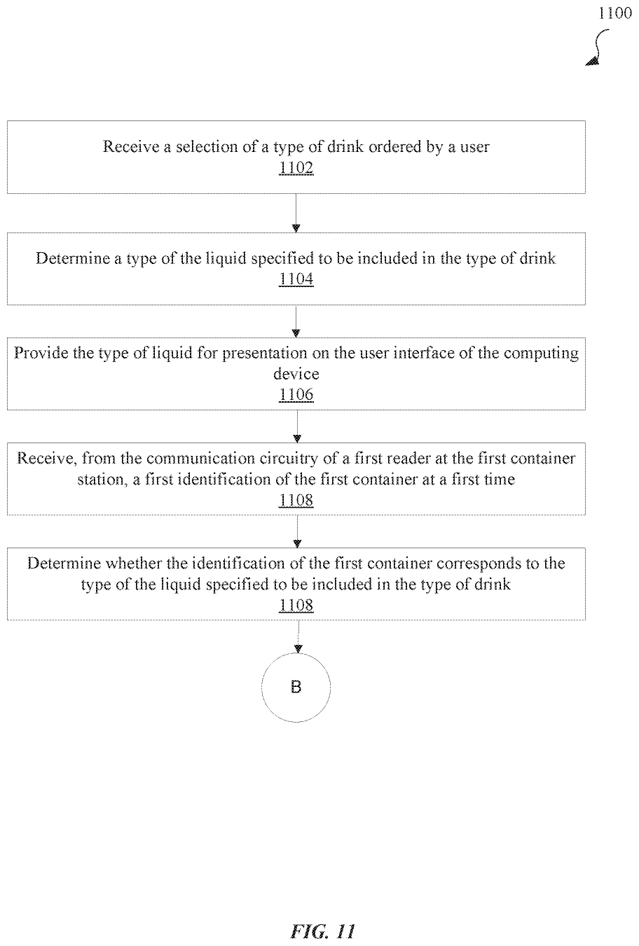

FIG. 11 shows a method 1100 in accordance with various embodiments. Method 1100 includes operations performed by processing devices of a computing system (e.g., computing device 230, server computing device 210, computing device 260, etc.) implementing the method 1100. In some embodiments, one or more operations of the method 1100 are implemented in computer instructions that are executable by a processing device. In some embodiments, the operations of the method 1100 may be performed by the computing device 230. The method 1000 may be performed in the same or a similar manner as described above in regards to method 900.

At block 1102, the processing device receives a selection of a type of drink ordered by a user. At block 1104, the processing device determines a type of liquid specified to be included in the type of drink. At block 1106, the processing device provides the type of liquid for presentation on the user interface of the computing device 230-1. At block 1108, the processing device receives, from the communication circuity 244-1 of a first reader 241-1 at the first container station 121-1, a first identification of the first container at a first time. At block 1108, the processing device determines whether the identification of the first container corresponds to the type of the liquid 235-1 specified to be included in the type of drink.

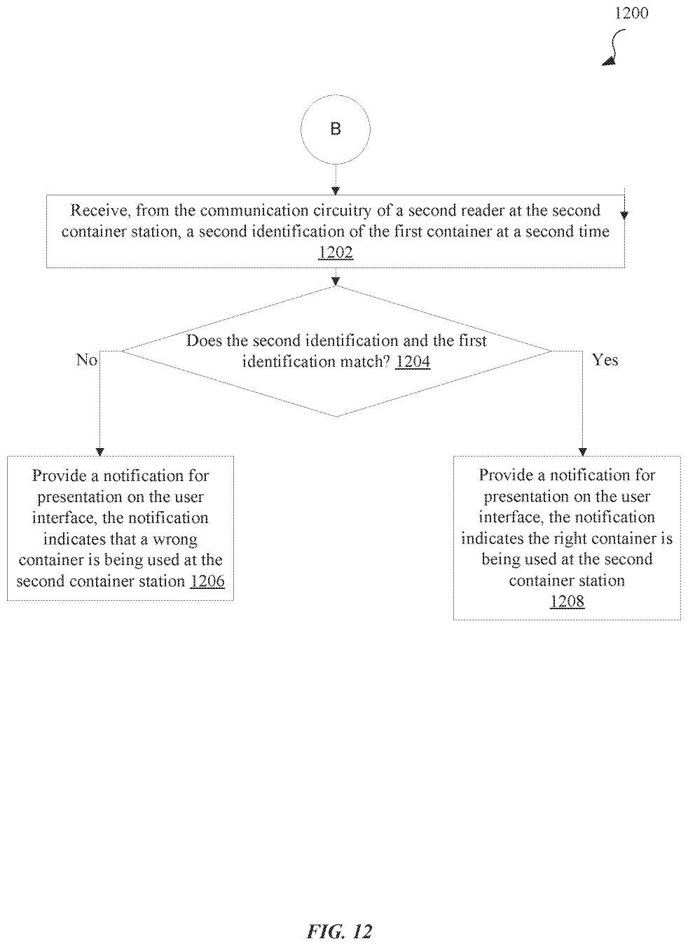

FIG. 12 shows a method 1200 in accordance with various embodiments. Method 1200 includes operations performed by processing devices of a computing system (e.g., computing device 230, server computing device 210, computing device 260, etc.) implementing the method 1200. In some embodiments, one or more operations of the method 1200 are implemented in computer instructions that are executable by a processing device. In some embodiments, the operations of the method 1200 may be performed by the computing device 230. The method 1200 may be performed in the same or a similar manner as described above in regards to method 900. The method 1200 may begin at block 1202 and include additional operations to the method 1100 in FIG. 11.

At block 1202, the processing device may receive, from the communication circuitry 224-1 of a second reader 220-1 at the second container station 120-1, a second identification of the first container 125-1 at a second time. At block 1204, the processing device determines whether the second identification and the first identification match. If not, the processing device provides, at block 1206, a notification indicating that a wrong container is being used at the second container station 120-1. If the identifications match, the processing device provides, at block 1208, a notification for presentation on the user interface, the notification indicates the right container is being used at the second container station 120-1.

FIG. 1300 shows a method 1300 in accordance with various embodiments. Method 1300 includes operations performed by processing devices of a computing system (e.g., computing device 230, server computing device 210, computing device 260, etc.) implementing the method 1300. In some embodiments, one or more operations of the method 1300 are implemented in computer instructions that are executable by a processing device. In some embodiments, the operations of the method 1300 may be performed by the computing device 230. The method 1300 may be performed in the same or a similar manner as described above in regards to method 900. The method 1300 may begin at block 1202 and include additional operations to the method 1100 in FIG. 11.

At block 1302, responsive to determining that the identification of the first container 125-1 does not correspond to the type of the liquid specified to be included in the drink, the processing device provides a notification for presentation on the user interface of the computing device 230-1. The notification indicates that the first container 125-1 is not specified to be included in the drink.

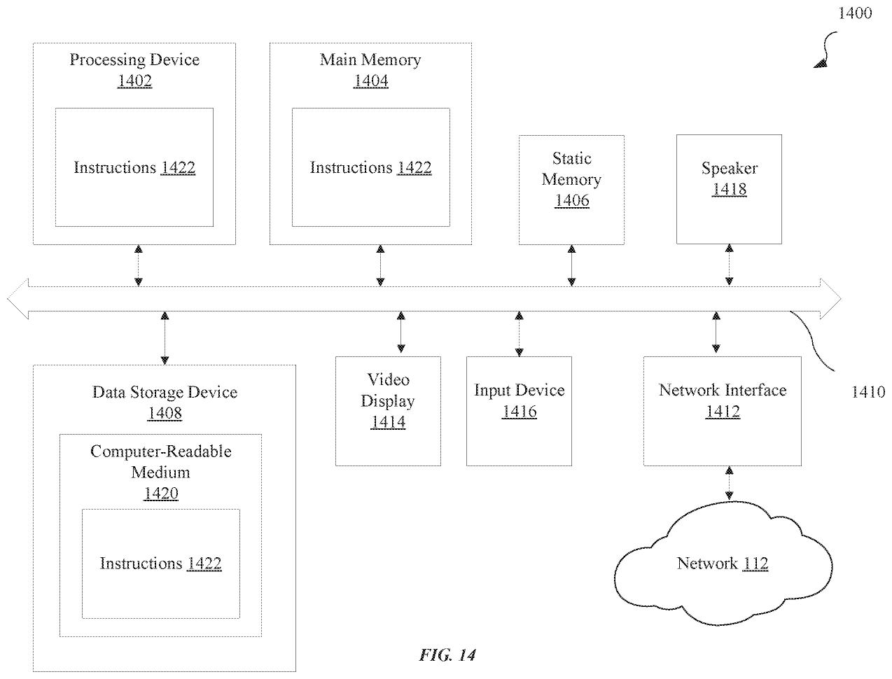

FIG. 14 shows a computer system 1400 in accordance with various embodiments. In one example, computer system 1400 may correspond to the server computing device 210, computing device 230-1, and/or computing device 260. Various components of the computer system 1400 may be included in the reader 220, camera 270, the weigh scale 237, the reader 241, the weigh scale 242. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a reader, a camera, a weigh scale, a set-top box (STB), a personal Digital Assistant (PDA), a mobile phone, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 1400 includes a processing device 1402, a main memory 1404 (e.g., read-only memory (ROM), flash memory, dynamic random access memory (DRAM) such as synchronous DRAM (SDRAM)), a static memory 1406 (e.g., flash memory, static random access memory (SRAM)), and a data storage device 1408, which communicate with each other via a bus 1410.

Processing device 1402 represents one or more general-purpose processing devices such as a microprocessor, central processing unit, or the like. More particularly, the processing device 1402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1402 may also be one or more special-purpose processing devices such as an application specific integrated circuit (ASIC), a field programmable gate array (FPGA), a digital signal processor (DSP), network processor, or the like. The processing device 1402 is configured to execute instructions for performing any of the operations and steps discussed herein.

The computer system 1400 may further include a network interface device 1412. The computer system 1400 also may include a video display 1414 (e.g., a liquid crystal display (LCD) or a cathode ray tube (CRT)), one or more input devices 1416 (e.g., a keyboard and/or a mouse), and one or more speakers 1418 (e.g., a speaker). In one illustrative example, the video display 1414 and the input device(s) 1416 may be combined into a single component or device (e.g., an LCD touch screen).

The data storage device 1416 may include a computer-readable medium 1420 on which the instructions 1422 (e.g., implementing any methods and any functions performed by any device and/or component depicted in the FIGURES and described herein) embodying any one or more of the methodologies or functions described herein is stored. The instructions 1422 may also reside, completely or at least partially, within the main memory 1404 and/or within the processing device 1402 during execution thereof by the computer system 1400. As such, the main memory 1404 and the processing device 1402 also constitute computer-readable media. The instructions 1422 may further be transmitted or received over a network via the network interface device 1412.

While the computer-readable storage medium 1420 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A method, comprising:
receiving, from communication circuitry of a first weigh scale, a first container weight of a first container, wherein the first container includes a liquid and is disposed on the first weigh scale at a first container station;
receiving, from communication circuitry of a second weigh scale, a first container weight of a second container, wherein the second container is disposed on the second weigh scale at a second container station;
receiving, from the communication circuitry of the first weigh scale, a second container weight of the first container after a portion of the liquid is removed from the first container;
receiving, from the communication circuitry of the second weigh scale, a second container weight of the second container after the portion of the liquid is added to the second container;
determining a removed weight of the portion of the liquid from the first container based on a difference between the first and second weight of the first container;
determining an added weight of the portion of the liquid in the second container based on a difference between the first and second weight of the second container; and
determining whether the removed weight and added weight match a target weight.

2. The method of claim 1, further comprising, responsive to determining that the removed weight and added weight match the target weight, providing a notification to indicate a match for presentation on a user interface of a computing device.

3. The method of claim 1, further comprising, responsive to determining that the removed weight and added weight do not match the target weight, providing a notification to indicate a mismatch for presentation on a user interface of the computing device.

4. The method of claim 1, further comprising presenting an indication of the added weight of the portion of the liquid on the user interface of the computing device in real-time while the portion of the liquid is being added to the second container.

5. The method of claim 1, further comprising:
receiving a selection of a type of drink ordered by a user;
determining a type of the liquid specified to be included in the type of drink; and
providing the type of the liquid for presentation on the user interface of the computing device.

6. The method of claim 5, further comprising:
receiving, from communication circuitry of a first reader at the first container station, a first identification of the first container at a first time, wherein the first identification is correlated with the first weigh scale; and
determining whether the identification of the first container corresponds to the type of the liquid specified to be included in the type of drink.

7. The method of claim 6, further comprising:
receiving, from the communication circuitry of a second reader at the second container station, a second identification of the first container at a second time; and
determining whether the second identification and first identification match.

8. The method of claim 7, further comprising, responsive to determining that the second identification and first identification do not match, providing a notification for presentation on the user interface, the notification indicates that a wrong container is being used at the second container station.

9. The method of claim 6, further comprising, responsive to determining that the identification of the first container does not correspond to the type of the liquid specified to be included in the drink, providing a notification for presentation on the user interface, the notification indicates that the first container is not specified to be included in the drink.

10. The method of claim 1, wherein the computing device is located at the second container station with the second weigh scale.

11. A tangible, non-transitory computer-readable medium storing instructions that, when executed, cause a processing device to:
receive, from communication circuitry of a first weigh scale, a first container weight of a first container, wherein the first container includes a liquid and is disposed on the first weigh scale at a first container station;
receive, from communication circuitry of a second weigh scale, a first container weight of a second container, wherein the second container is disposed on the second weigh scale at a second container station;
receive, from the communication circuitry of the first weigh scale, a second container weight of the first container after a portion of the liquid is removed from the first container;
receive, from the communication circuitry of the second weigh scale, a second container weight of the second container after the portion of the liquid is added to the second container;
determine a removed weight of the portion of the liquid from the first container based on a difference between the first and second weight of the first container;
determine an added weight of the portion of the liquid in the second container based on a difference between the first and second weight of the second container; and
determine whether the removed weight and added weight match a target weight.

12. The computer-readable medium of claim 11, wherein, responsive to determining that the removed weight and added weight do not match the target weight, the processing device executes the instructions to provide a notification to indicate a mismatch for presentation on the user interface of the computing device.

13. The computer-readable medium of claim 11, wherein, responsive to determining that the removed weight and added weight match the target weight, provide a notification to indicate a match for presentation on a user interface of a computing device.

14. The computer-readable medium of claim 11, wherein the processing device executes the instructions to present an indication of the added weight of the portion of the liquid on a user interface of the computing device in real-time while the portion of the liquid is being added to the second container.

15. The computer-readable medium of claim 11, wherein the processing device executes the instructions to:
receive a selection of a type of drink ordered by a user;
determine a type of the liquid specified to be included in the type of drink; and
provide the type of the liquid for presentation on the user interface of the computing device.

16. The computer-readable medium of claim 15, wherein the processing device executes the instructions to:
receive, from the communication circuitry of a first reader at the first container station, a first identification of the first container at a first time, wherein the first identification is correlated with the first weigh scale; and
determine whether the identification of the first container corresponds to the type of the liquid specified to be included in the type of drink.

17. A system comprising:
a first location comprising a first weigh scale and a first container disposed on the first weigh scale, wherein the first container contains liquid and the first weigh scale configured to weigh the first container;
a second location comprising a second weigh scale and a second container disposed on the second weigh scale, wherein the second weigh scale is configured to weigh the second container;
an alarm; and
a computing device comprising:
a network interface communicatively coupled to the first weigh scale, the second weigh scale, and the alarm;
a memory device storing instructions;
a processing device operatively coupled to the network interface and the memory device, wherein the instructions cause the processing device to:
receive a first container weight of a first container, wherein the first container includes a liquid and is disposed on the first weigh scale at a first container station;
receive a first container weight of a second container, wherein the second container is disposed on the second weigh scale at a second container station;
receive a second container weight of the first container after a portion of the liquid is removed from the first container;
receive a second container weight of the second container after the portion of the liquid is added to the second container;
determine a removed weight of the portion of the liquid from the first container based on a difference between the first and second weight of the first container;
determine an added weight of the portion of the liquid in the second container based on a difference between the first and second weight of the second container; and
determine whether the removed weight and added weight match a target weight.

18. The system of claim 17, wherein, responsive to determining that the removed weight and added weight do not match the target weight, the processing device executes the instructions to provide a notification to indicate a mismatch for presentation on a user interface of the computing device.

19. The system of claim 17, wherein, responsive to determining that the removed weight and added weight match the target weight, provide a notification to indicate a match for presentation on a user interface of a computing device.

20. The system of claim 17, wherein the processing device executes the instructions to:
receive a selection of a type of drink ordered by a user;
determine a type of the liquid specified to be included in the type of drink; and
provide the type of the liquid for presentation on the user interface of the computing device.
